(19) United States
(12) Patent Application Publication
(10) Pub. No.: US 2008/0216304 A1
(43) Pub. Date: Sep. 11, 2008

(54) METHOD OF MANUFACTURING ANTENNA MODULE BY LASER CARVING

(76) Inventors: Chien Ming Lin, Pa-Te City (TW); Chuang Han Li, Pa-Te City (TW); Daniel Chang, Pa-Te City (TW); Yu-Shu Chao, Pa-Te City (TW)

Correspondence Address: SINORICA, LLC, 528 FALLSGROVE DRIVE, ROCKVILLE, MD, 20850, US

(21) Appl. No.: 11/682,868

(22) Filed: Mar. 6, 2007

(51) Int. Cl. C23C 4/08; B23K 26/36; B23K 26/00

(52) U.S. Cl. 29/600; 219/121.69

(57) ABSTRACT

A method of manufacturing antenna by laser carving comprising the following steps: to attach metal material such as copper, silver etc. onto the base plate by a method of conductive coating by spraying; and then to trim the metal material to complete the shape of an antenna by laser carving. Thereby, the size and shape of the antenna are not limited, and the antenna can be manufactured on a non-planar base plate, thus the height of the entire antenna module can be reduced.

### BACKGROUND OF THE INVENTION

1. Field of the Invention

The present invention relates to a method of manufacturing antenna by laser carving, and especially to a method of manufacturing antenna in which laser carving is used directly to trim metal material attached to a base plate.

2. Description of the Prior Art

By virtue that the mobile communication technique is advanced rapidly, utilization of portable electronic products such as mobile phones and notebooks etc. are more popular. These portable electronic products meet the requirement of portability, and thereby they are developed all the way following the tendency of miniaturization, and thereby their interior elements are more and more reduced by size. Antennas now mostly are planar antennas for meeting such tendency.

In manufacturing such conventional planar antennas, as shown in FIG. 1, an antenna 1 made of metal material (such as copper) is formed by punching, and then is stuck on a plastic plate 2 to form an antenna combination. By the fact that the antenna 1 made of metal material is formed by punching, it is insufficient in precision, thereby it is unable to be used to form an antenna of small size, this makes a conventional antenna combination inevitably occupy quite a space in a portable electronic product.

Moreover, by the fact that the antenna 1 made of metal material is formed by punching, shape of the antenna 1 is limited to being formed a planar plate to be stuck on the plastic plate 2, and it is unable to be stuck on a non-planar plastic plate; this is another problem in manufacturing and is necessary to be solved.

In an international patent application PCT/IL2005/000611 “Three Dimensional Antennas Formed Using Wet Conductive Materials and Methods for Production thereof” of which the international publication date is Dec. 22, 2005 according to the Patent Cooperation Treaty (PCT), an antenna producing method provides a base plate at least having a three dimensional surface, the base plate at least having a three dimensional surface is treated by conductive coating to form an antenna at least on one of the surfaces.

By virtue that the prior art (the international patent application) forms three dimensional antennas by using the technique of conductive coating, and there is a requirement for broadband and compactness on electronic products, shapes of antennas get more and more complicated, a sole simple technique of conductive coating is unable to make the shapes or patterns of the antennas required.

### SUMMARY OF THE INVENTION

The present invention provides a brand new method of manufacturing antennas by laser carving against the defects resided in manufacturing conventional planar antennas; it includes the following steps: metal material is attached by a method of conductive coating by spraying onto a base plate, then laser carving is used to trim metal material to complete the shape of an antenna. Wherein the base plate can be made of plastic, ceramic, paper or alloy of magnesium and aluminum, or can be a part of a portable electronic product, thereby the entire antenna has no more space limitation, thus it meets the above requirement for compactness; and by virtue that the shape of the antenna is completed by laser carving, the antenna can be of any complicated or compacted shape; the scope of utilization in manufacturing antennas thus can be wider.

In the mean time, by virtue that in the present invention, the shape of an antenna is completed by trimming of laser carving, this has extreme high precision, therefore, the technique can be used to produce antennas of various sizes.

And more, the present invention completes the shape of an antenna by laser carving after the base plate is treated by spraying conductive coating material or after the generally shape of the antenna is formed, whereby the base plate can be non-planar such as arciform or even a 3D shape.

Besides, the method of manufacturing of the present invention is also applicable to manufacturing a matching circuit board on a base plate, and applicable to the surface sticking technique (STM) to apply tin soldering paste onto a printed circuit board.

The present invention will be apparent in its steps of manufacturing and effects after reading the detailed description of the preferred embodiment thereof in reference to the accompanying drawings.

### BRIEF DESCRIPTION OF THE DRAWINGS

FIG. 1 is an anatomic perspective view showing an antenna made by a conventional punching method;

FIG. 2 is a process flow chart of the present invention;

FIG. 3 is a perspective view showing the appearance of a first embodiment of antenna made by the present invention;

FIG. 4A is a standing wave voltage ratio (VSWR) diagram for the conventional punching method in manufacturing antennas;

FIG. 4B is a standing wave voltage ratio (VSWR) diagram for the method of the present invention in manufacturing antennas;

FIG. 5A is a diagram showing a gain in manufacturing antennas of which the frequency in a horizontal water level is 880 MHz for the conventional punching method;

FIG. 5B is a diagram showing a gain in manufacturing antennas of which the frequency in a horizontal water level is 880 MHz for the method of the present invention.

### DETAILED DESCRIPTION OF THE PREFERRED EMBODIMENT

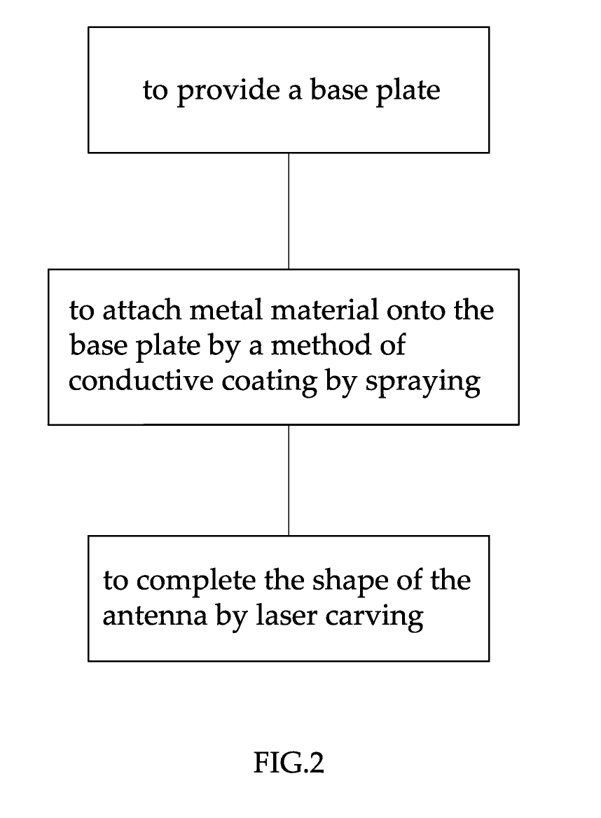

Referring to FIG. 2 which is a process flow chart of the present invention, the steps of the process include:

To provide a base plate 20;

to attach metal material onto the base plate 20 by a method of conductive coating by spraying; and

to trim metal material to complete the shape of an antenna 10 by laser carving.

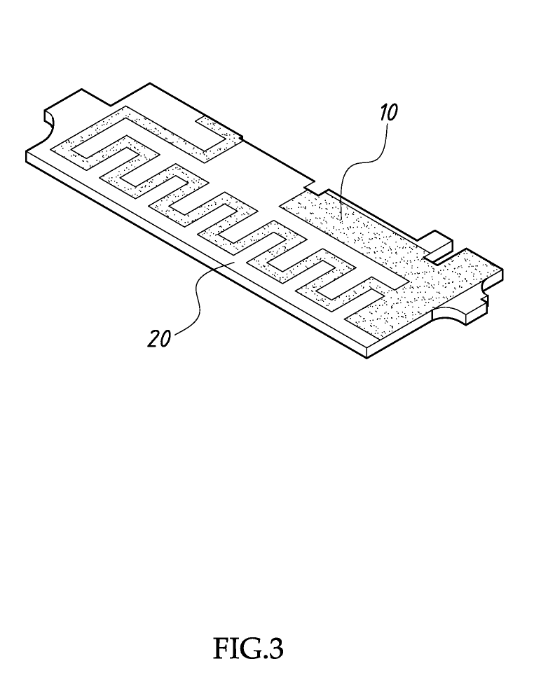

Referring to FIG. 3 which shows a first embodiment of antenna made by the present invention, after metal material is attached onto the base plate 20 by a method of conductive coating by spraying, it is trimmed by laser carving to complete the shape of the antenna 10. Wherein the method of conductive coating by spraying, which can be any of the methods including spray painting, immersion, applying and electroplating etc., attaches conductive metallic material such as copper, silver etc. to the base plate 20. The material of the base plate 20 can be plastic, ceramic, paper or alloy of magnesium and aluminum, or can be formed a housing or a part of an internal circuit board of a portable electronic product. Surely, the base plate 20 does not have to be planar, it can be non-planar such as arciform or even a 3D shape.

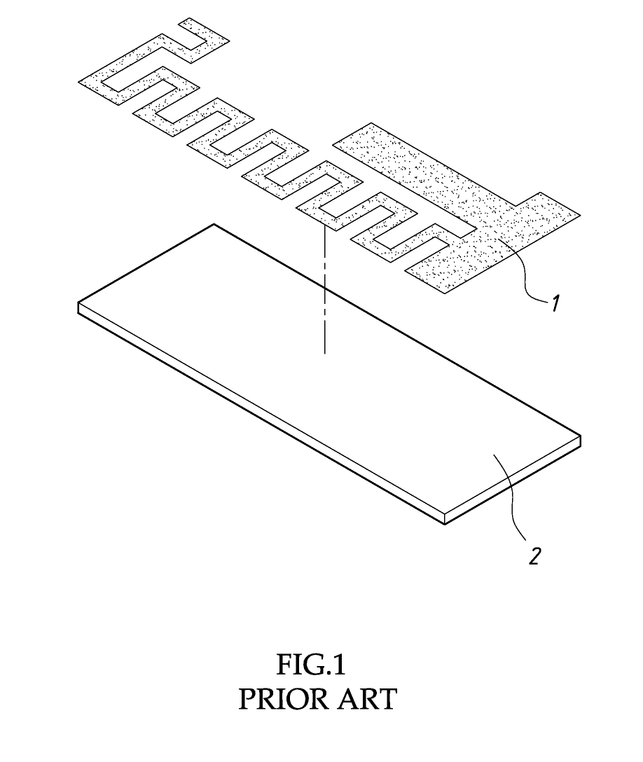

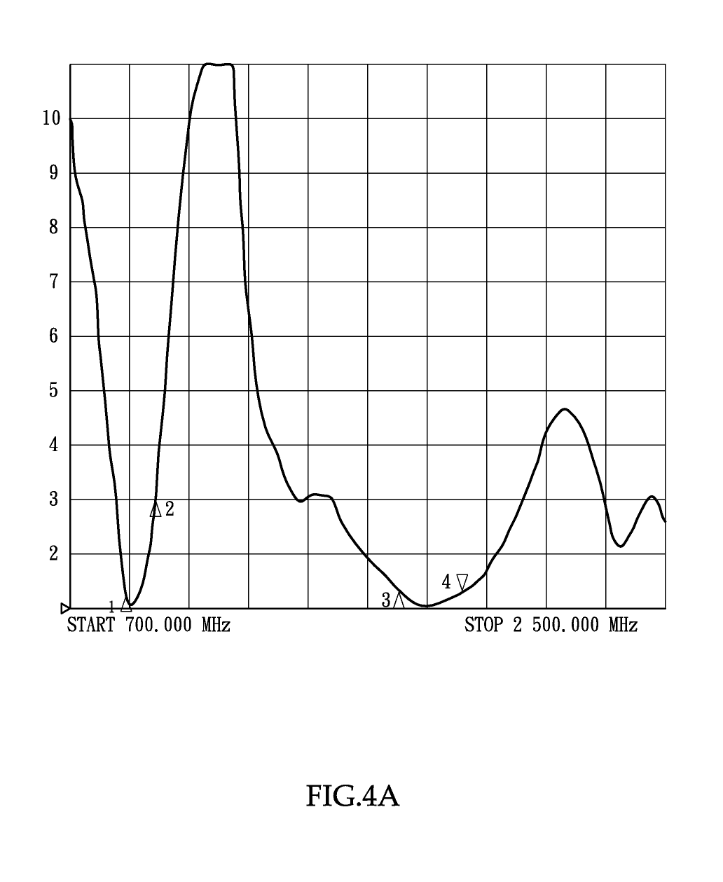

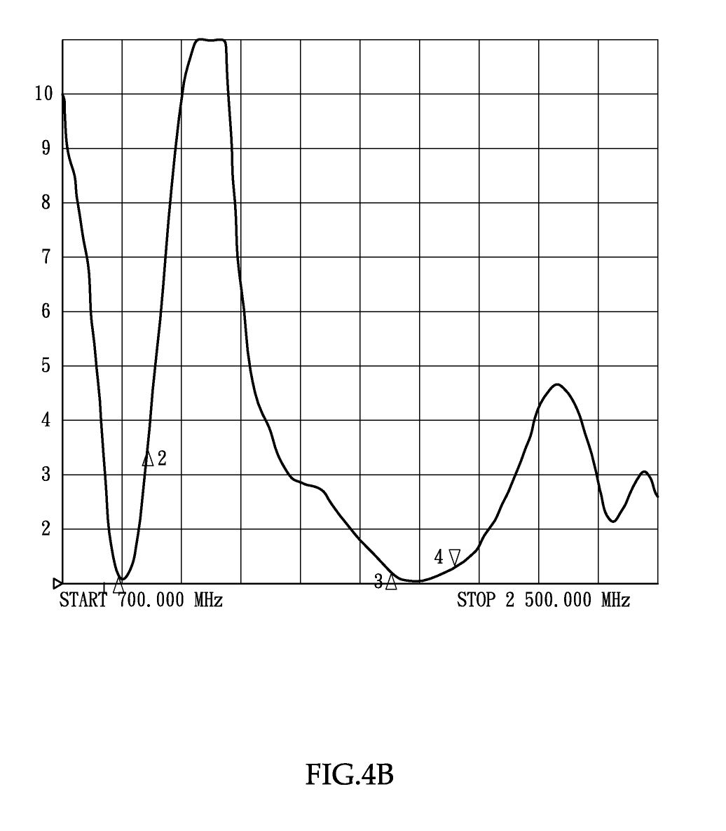

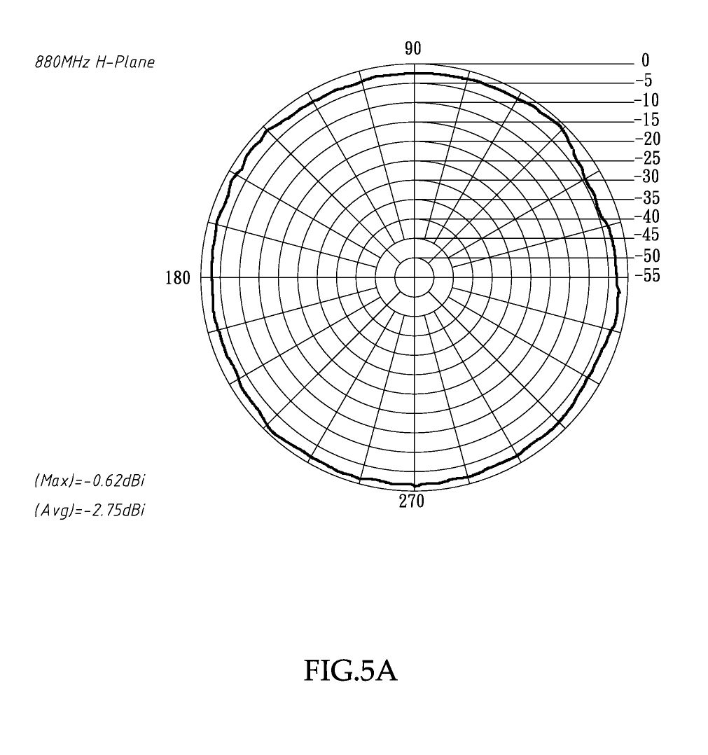

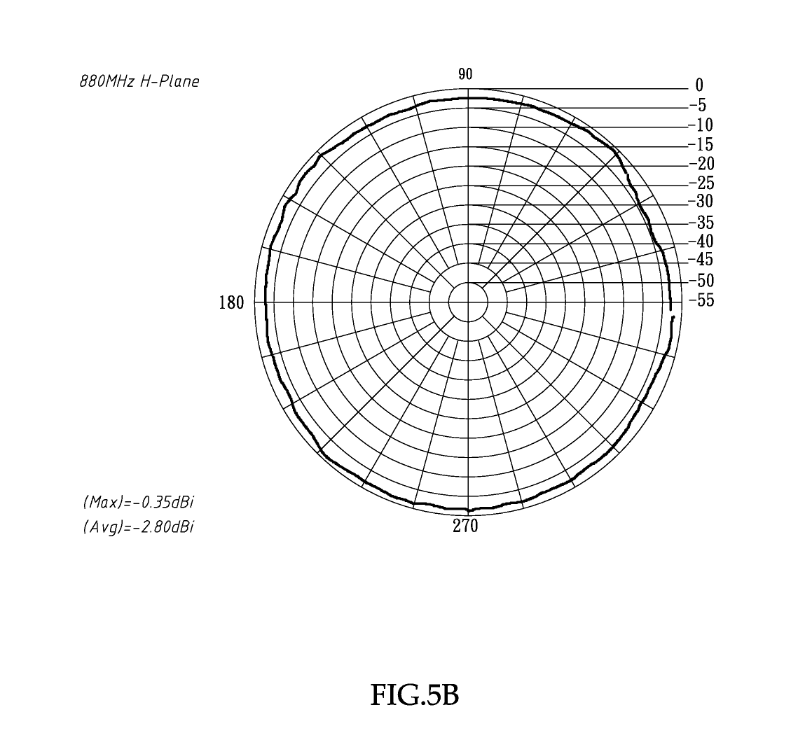

Referring to FIGS. 4A and 4B as well as FIGS. 5A and 5B, the drawings are for antennas of identical shapes provided for experimental comparison, and the antennas are made respectively by the conventional punching method (as shown in FIG. 1) and the method of the present invention (as shown in FIG. 3).

FIGS. 4A is a standing wave voltage ratio (VSWR) diagram for the conventional punching method in manufacturing antennas, while FIG. 4B is a standing wave voltage ratio (VSWR) diagram for the method of the present invention in manufacturing antennas; the situations of the two are very close to each other. FIG. 5A is a diagram showing a gain in manufacturing antennas of which the frequency in a horizontal water level is 880 MHz for the conventional punching method, while FIG. 5B is a diagram showing a gain in manufacturing antennas of which the frequency in a horizontal water level is 880 MHz for the method of the present invention; the largest gains of the two and their average gains are nearly same as the other of themselves. Therefore, the antennas made by the method of the present invention are practicable.

Further, in addition to being applicable to manufacture antennas, the method of manufacturing by laser carving of the present invention is also applicable to manufacturing a matching circuit board on a base plate, for instance, the base plate is treated by spraying copper thereon in advance, then the matching circuit board can be completed by laser carving; surely, the present invention is also applicable to the surface sticking technique (STM) to apply tin soldering paste onto a printed circuit board; this is a simple application of the present invention which is within the scope of the appended claims to be protected.

Having thus described the technical process of my invention having high industrial value, what I claim as new and desire to be secured by Letters Patent of the United States is:

1. A method of manufacturing antenna by laser carving comprising following steps:
to provide a base plate;
to attach metal material onto said base plate by a method of conductive coating by spraying; and
to trim said metal material to complete a shape of an antenna by laser carving.

2. The method of manufacturing antenna by laser carving as defined in claim 1, wherein material of said base plate is chosen from plastic, ceramic, paper or alloy of magnesium and aluminum.

3. The method of manufacturing antenna by laser carving as defined in claim 1, wherein said base plate is planar.

4. The method of manufacturing antenna by laser carving as defined in claim 1, wherein said base plate is non-planar.

5. The method of manufacturing antenna by laser carving as defined in claim 1, wherein said method of conductive coating by spraying to attach said metal material onto said base plate is chosen from spray painting, immersion, applying and electroplating.
